(19) United States
(12) Patent Application Publication
(10) Pub. No.: US 2013/0125993 A1
(43) Pub. Date: May 23, 2013

(54) SYSTEM AND METHOD FOR COATING A METAL PIPE AND COATED PIPE MADE THEREFROM

(71) Applicants: Russel A. Rickerson, Rantoul, KS (US); Larry D. Burkdoll, Princeton, KS (US)

(72) Inventors: Russel A. Rickerson, Rantoul, KS (US); Larry D. Burkdoll, Princeton, KS (US)

(73) Assignee: Advance Pipe Lining, LLC, Garnett, KS (US)

(21) Appl. No.: 13/674,916

(22) Filed: Nov. 12, 2012

Related U.S. Application Data
(60) Provisional application No. 61/558,746, filed on Nov. 11, 2011.

(51) Int. Cl. F16L 9/14

(52) U.S. Cl. CPC F16L 9/14
USPC 137/1; 138/146; 427/231; 118/318

(57) ABSTRACT

The present invention relates to a system and method for coating the interior surface of a pipe, which coated pipe can then be used in the transmission of corrosive petroleum fluids.

### RELATED APPLICATION

This application relates to and claims the priority of U.S. Provisional Patent Application No. 61/558,746, which was filed Nov. 11, 2011 and is hereby incorporated by reference in its entirety.

### FIELD OF THE INVENTION

The present disclosure generally relates to a system and method for applying a protective coating to the interior surface of a metal pipe, as well as the coated pipe made therefrom. Specifically, the present disclosure provides a method and apparatus for evenly and uniformly applying an anti-corrosive flexible resin coating along the interior surface of a metal pipe, which resultant coated pipe can then be used in the transmission of corrosive fluids, for example, saltwater or petroleum based fluids, such as oil and gas.

### BACKGROUND OF THE INVENTION

Pipelines and/or underground transport of liquids and gases have proven to be an efficient and safe manner in which to transport potentially explosive, flammable, corrosive, and/or toxic liquids (e.g., crude oil) and gases (e.g., methane and propane) over long distances. For pipelines constructed of metal which transport these liquid materials, contact with the liquid material causes severe corrosion to the internal surface of the pipeline. Gas pipelines accumulate condensate, which contacts the internal surfaces of the pipeline causing corrosion. Once pipelines become damaged from corrosion, they need to be replaced, which is often costly, difficult, and time-consuming. To prevent this corrosive contact, pipes are usually coated at the factory with a protective coating.

Early devices and methods for applying protective coating material to the inside of pipes involved a means for centrifugally forcing the coating material onto the interior of the pipe and then troweling the coating material into place. One such device utilizing this type of application is illustrated in U.S. Pat. No. 1,988,329. One of the problems with this type of application is that the resulting coating is not uniform in thickness.

Other devices and methods for applying coating materials involve slinging the coating material radially outward against the pipe wall. Examples of these types of devices can be found in U.S. Pat. Nos. 3,017,855, 3,071,107, 3,753,766 and 4,938,167. Again, the problem with these methods and devices is that the thickness of the material on the interior of the pipe cannot be adequately controlled.

Yet another method for applying a protective coating material to the inside of a pipe is shown in U.S. Pat. No. 2,158,579, which discloses brushing the coating onto the inside of a pipe. However, the brush bristles do not apply the material in a uniform manner and the resulting coating may have gaps and runs.

Yet another method and device for applying coating materials along the interior of a pipe involves inserting a spray machine inside the pipe, wherein the spray head rotates to provide coverage to the interior of the pipe. Examples of such devices can be found in U.S. Pat. Nos. 5,092,265, 5,181,962, and 7,338,687. The problem with these spray devices is that they are bulky and cannot be used with pipes having small diameters, for example, diameters of less than 3 inches, in order to provide a coating having a uniform thickness.

The prior art also discloses coated pipes that are formed as a result of different methods and devices. An example of a coated pipe is set forth in U.S. Pat. No. 4,169,906. However, the coated pipes found in the art are generally comprised of a resin-based coating material that is not flexible. The coatings used in the art therefore do not allow the pipe, once coated, to be bent as may be required by pipeline systems.

Accordingly, it would be desirable to provide methods and devices for uniformly coating a metal pipe with a flexible coating prior to use of the resultant coated pipe in a pipeline. In particular, there is a need in the art for use of pipes being uniformly coated with a flexible coating in order to allow for increased use in the transportation of highly corrosive fluid streams.

### SUMMARY OF THE INVENTION

It is an object of the present invention to provide a novel system for the application of a smooth and uniform protective flexible resin coating to the interior surface of a metal pipe, which resultant coated pipe can then be used in the transmission of corrosive fluids.

In an embodiment, a system for smoothly and uniformly coating an interior surface of a pipe is described, which system comprises a reservoir for receiving a quantity of a coating composition, a flexible conduit in fluidic communication with the reservoir, a structure for withdrawing the flexible conduit from the pipe at a selected and controlled rate of speed, and an assembly configured to axially rotate the pipe.

In an alternative embodiment, a system and method for smoothly and uniformly coating an interior surface of a pipe is described, which system first comprises a pumping unit for receiving a quantity of a coating composition and a catalyst. The pumping unit is placed in fluidic communication with an injection unit, wherein the injection unit generally comprises a flexible conduit and a drive mechanism. The coating composition is metered into the injection unit through the pumping unit. The pumping unit discharges a selected volume of the coating composition into the flexible conduit, which volume is predetermined to be sufficient to evenly coat the entire interior of the pipe, depending upon the interior diameter and length of the pipe to be coated. The drive mechanism of the injection unit withdraws or retracts the flexible conduit from the interior of the pipe at a selected and controlled rate of speed while the coating composition is deposited along the interior of the pipe through the flexible conduit. An assembly configured to axially the pipe and to hold a number of pipes in a horizontal formation comprises a drive mechanism to spin or rotate the pipes. After the flexible conduit is withdrawn entirely from the pipe, the rotating assembly is engaged and the pipe is rotated at a selected rate of speed about its horizontal axis. The rotation of the pipe or pipes on the assembly distributes the coating composition smoothly and with uniform thickness along the entire interior surface of the pipe through the use of centrifugal force.

In another embodiment, a method for smoothly and uniformly applying a coating composition to an interior surface of a pipe used in the transmission of corrosive fluids is described. The method generally comprises the steps of (1) supplying a quantity of a coating composition to a flexible conduit; (2) inserting the flexible conduit into the interior of the pipe; (3) depositing the coating composition into the pipe through the flexible conduit while the flexible conduit is withdrawn from the pipe at a selected rate of speed; and (4) rotating the pipe on an apparatus configured to axially rotate a pipe at a selected rate of speed to smoothly and uniformly apply the coating composition to the interior of the pipe.

The coated pipe prepared in accordance with the system and method of the present invention provides several advantages over the prior art, including improved resistance to corrosion by virtue of the fact that the coating as applied is smooth and of uniform thickness around the entire inner diameter of the pipe, as well as increased flexibility and strength due to the resin composition that is integrally and uniformly applied to the pipe interior.

Additional objectives, advantages and novel features will be set forth in the description which follows or will become apparent to those skilled in the art upon examination of the drawings and detailed description which follows.

### BRIEF DESCRIPTION OF DRAWINGS

FIG. 1 is a schematic diagram of the system for coating the interior surface of a pipe.

FIG. 2 is a schematic diagram of the pumping unit.

FIG. 3 is a cross-sectional side view of the injection unit.

FIG. 4 is a rear view of the injection unit.

FIG. 5 is a perspective view of the flexible conduit used in the injection unit.

FIG. 6 is a cross-sectional view of a pipe being coated by the injection unit in accordance with the present invention.

FIG. 7 is a front view of the assembly configured to rotate a pipe.

FIG. 8 is a cross-sectional view of the assembly configured to rotate a pipe.

FIG. 9 is a side view of the assembly configured to rotate a pipe.

FIG. 10 is a perspective view of the assembly configured to rotate a pipe.

FIG. 11 is a front view of the assembly configured to rotate a pipe.

FIG. 12 is a perspective view of the resultant coated pipe.

### DETAILED DESCRIPTION OF PREFERRED EMBODIMENTS

The present invention relates to a system and method for applying a coating composition to the interior surface of a pipe, which coated pipe may be used in the transmission of corrosive fluids. The system and method are especially suitable for use in conjunction with the coating of metal pipes used in the oil and gas industry. The present invention improves existing processes for coating the interior surface of a pipe. By rotating or spinning the pipe at a predetermined rate of speed (or revolutions per minute (rpm or rpms)) subsequent to a coating composition being deposited on the interior surface of the pipe, the coating composition can be smoothly applied to the interior surface of the pipe at a uniform thickness, which, when cured, provides an improved coating to the interior surface of the pipe.

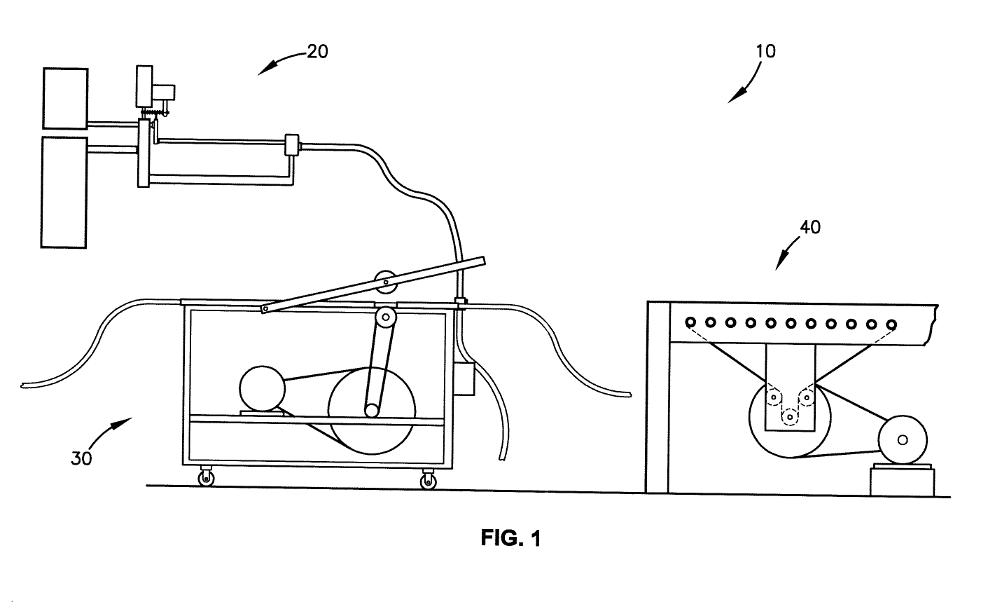

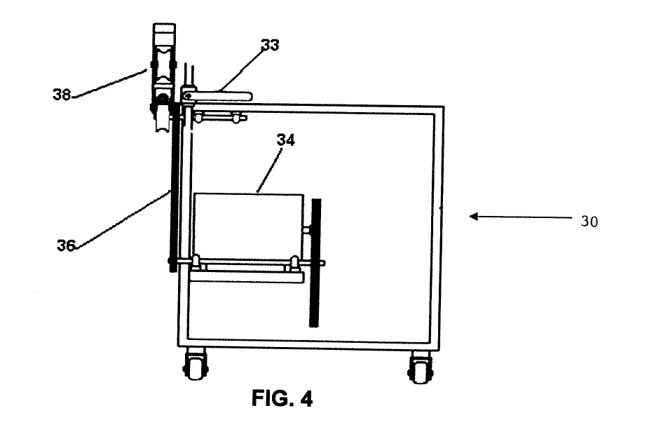

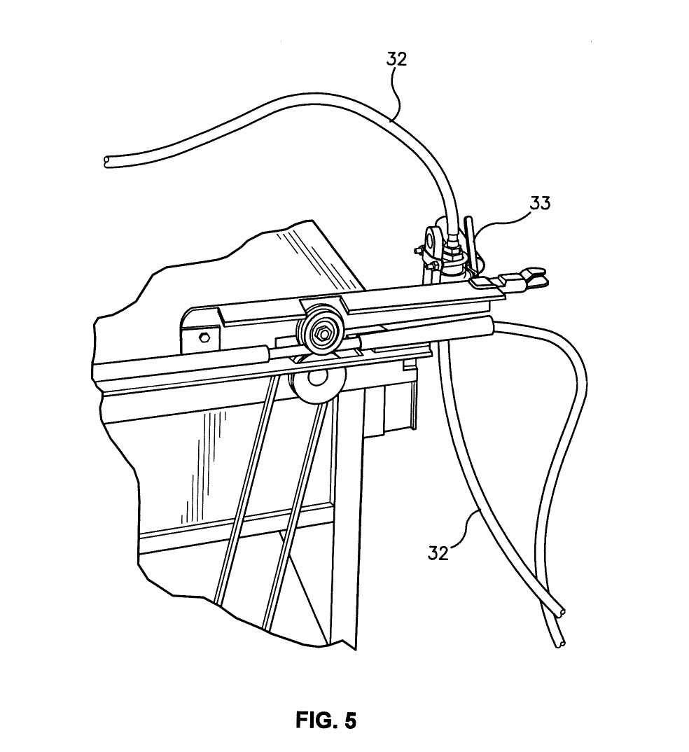

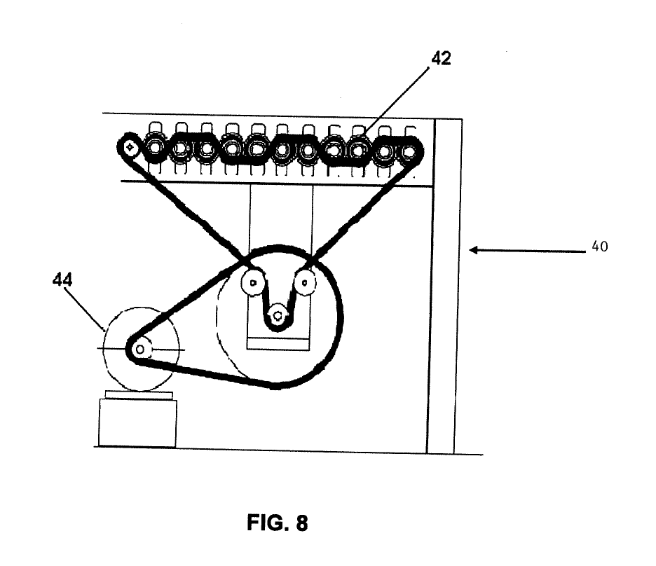

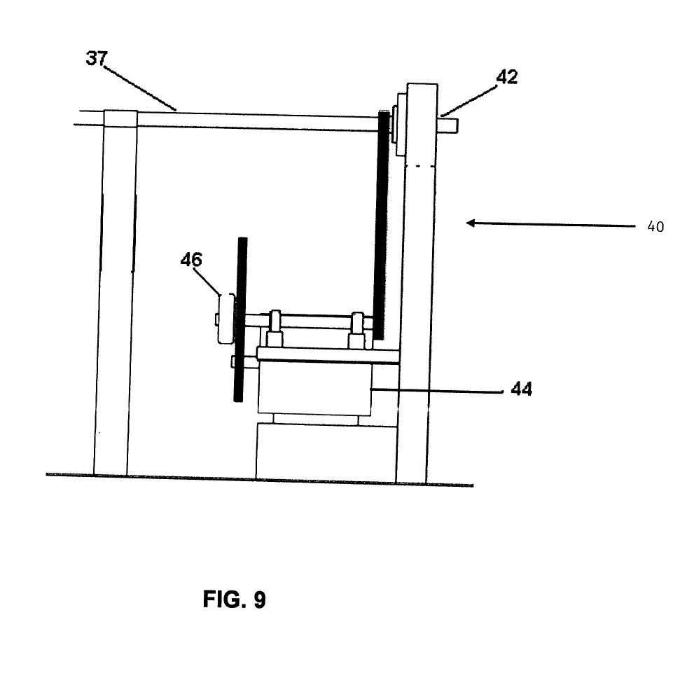

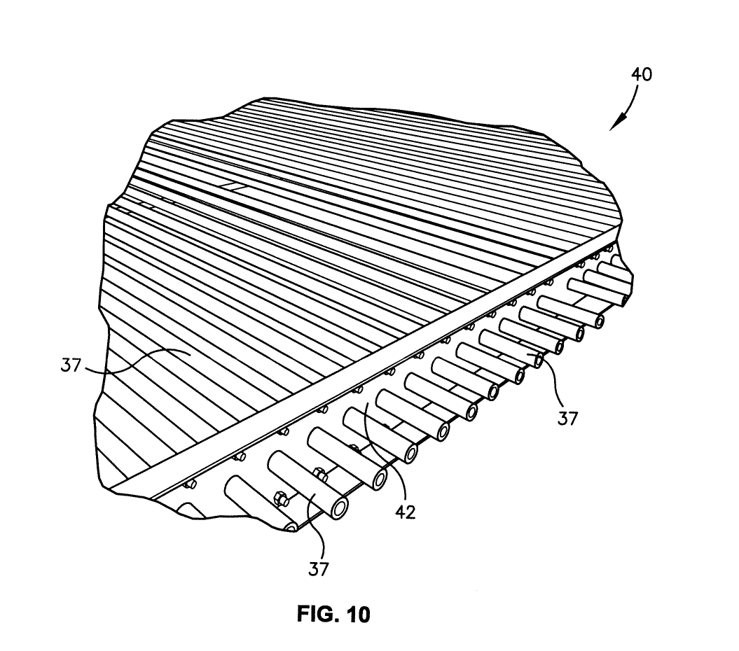

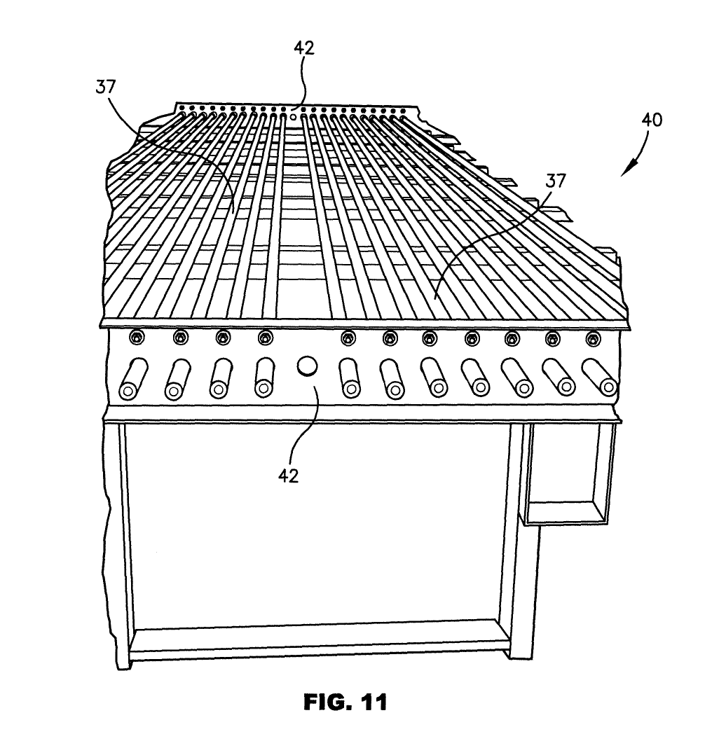

Referring to the drawings (FIGS. 1-12), a pipe coating system 10, method for coating the interior surface of a pipe, and resultant coated pipe 50 are shown and described. The pipe coating system 10 is for use with any pipe to be coated and which may be used in a pipeline to transport corrosive fluids such as, for example, oil, gas, and saltwater. The pipe coating system 10 of the present invention is for use in coating individual pipes prior to placement of the pipes in a pipeline and is not suited for in place coating of pipes after the pipes have already been placed in a pipeline.

The pipe to be coated by the system of the present invention may be metal, such as steel, aluminum, copper, brass, bronze, cast iron, etc., or the pipe may be plastic, concrete or fiberglass. In one embodiment, the pipe to be coated is a metal pipe. In a preferred embodiment, the pipe to be coated is a steel pipe. The pipe coating system 10 of the present invention is capable of coating pipes having a variety of interior diameters, preferably pipes having an interior diameter of less than 3″, and more preferably pipes having an interior diameter of about 1″. The pipe coating system 10 of the present invention is also capable of coating pipes that have a variety of lengths, preferably a length of at least about 6″, more preferably a length of between about 10 feet and about 50 feet, even more preferably a length of between about 20 feet and 40 feet, and most preferably a length of between about 25 feet and about 30 feet in length. As illustrated in FIG. 1, the pipe coating system 10 of the present invention comprises a combination of assemblies, articles, and devices that work together to form the coating composition, deposit the coating composition to the interior surface of the pipe, and disperse the coating composition smoothly and uniformly about the entire interior surface of the pipe. The pipe coating system 10 is generally comprised four main elements; a reservoir for receiving a quantity of a coating composition, a flexible conduit in fluidic communication with the reservoir 32, a means for withdrawing the flexible conduit from the pipe at a selected and controlled rate of speed, and an assembly configured to axially rotate the pipe 40.

The method of coating a pipe generally comprises the steps of (1) supplying a quantity of a coating composition to a flexible conduit; (2) inserting the flexible conduit into the interior of the pipe; (3) depositing the coating composition into the pipe through the flexible conduit while the flexible conduit is withdrawn from the pipe at a selected rate of speed; and (4) rotating the pipe on an apparatus configured to axially rotate a pipe at a selected rate of speed to smoothly and uniformly apply the coating composition to the interior of the pipe.

The coating composition used in the present invention comprises anti-corrosion properties. The general composition of the present invention comprises any synthetic resin-based coating material available in the industry, to which a combination of additional components are added to improve the quality of the coating composition and ultimately, the tensile strength of the coated pipe. These additional components include fillers (including fibrous reinforcements), cross-linking agents, and other ingredients, such as pigments. The resin-based coating material may be a polyester resin, vinyl ester resin, epoxy resin, nylon resin, or combinations thereof. Preferably an unsaturated polyester resin is used. An example of a resin-based coating material that can be used in the present invention is a Stypol® unsaturated polyester resin.

The coating composition preferably includes a liquid unsaturated monomeric cross-linking agent capable of polymerizing with the polyester, for example, styrene, diallyl phthalate, methyl methacrylate, and ring-substituted styrenes such as vinyltoluene, divinylbenzene, t-butyl styrene, and chlorostyrenes.

The coating composition also may include fillers, which are added to the composition as extenders to impart such properties as heat resistance, improved tensile strength, and reduction in tendency to crack during cure. Fillers, including fibrous reinforcements, tend to improve the tensile strength of the coated object. Examples of fillers that can be used are calcium carbonate, talc, clays, hydrated alumina, calcium silicate, silica, mica, and microspheres made from glass and other materials. An example of fibrous reinforcements that can be used are glass fibers, which may be ground, chopped, strands, fabrics, etc. Tensile strength, as used herein, is defined as the maximum load that an object can support without fracture, divided by the cross-sectional area of the object. Tensile strength is commonly expressed as pounds per square inch, or psi. In one embodiment, the coating composition provides the coated pipe with a tensile strength of less than or equal to 85,000 psi. In another embodiment, the coating composition provides the coated pipe with a tensile strength less than or equal to 50,000 psi.

Other materials can also be included in the coating composition to obtain special effects, such as pigments or dyestuffs, mold release additives, etc.

In a preferred embodiment, the coating composition additionally comprises a flex agent or flex additive. A flex agent is a material added to a plastic-based coating to impart flexibility to the coating and as a result, the object being coated. Different types of flex agents are known in the art and include, but are not limited to, putty resins. The flex agent is added to the coating composition to provide flexibility to the coating once it hardens or cures inside the pipe. Inclusion of a flex agent in the coating composition has been observed to provide increased flexibility to the resultant coated pipe, such that the coated pipe has a bending radius of less than or equal to 4 feet, preferably from about ¼″ to about 4 feet. In one embodiment, the coating composition comprises polyester resin, ground fiberglass, putty resin, styrene, calcium carbonate, and a pigment.

To form the coating composition, the components described above are combined or mixed together in a reservoir 12. Any reservoir or container can be used to hold the components during mixing, such as, for example, an industrial mixer. The coating composition is heated by agitation in the reservoir 12 until the composition reaches a temperature of between about 95° F. and about 115° F., preferably between about 100° F. and about 110° F., and more preferably between about 105° F. and about 108° F.

It should be noted that prior to being supplied to the flexible conduit, the coating composition must be combined with an accelerator or a catalyst in order to initiate polymerization of the coating composition into a solid thermoset inside the pipe. Common catalysts that are typically used with polyester resins include organic peroxides, such as methyl ethyl ketone peroxide (MEKP), benzoyl peroxide, acetone peroxide, t-butyl perbenzoate, t-butyl hydroperoxide, succinic acid peroxide, cumene hydroperoxide, dibenzoyl peroxide, and the like. In one embodiment, the catalyst to be combined with the resin mixture is benzoyl peroxide.

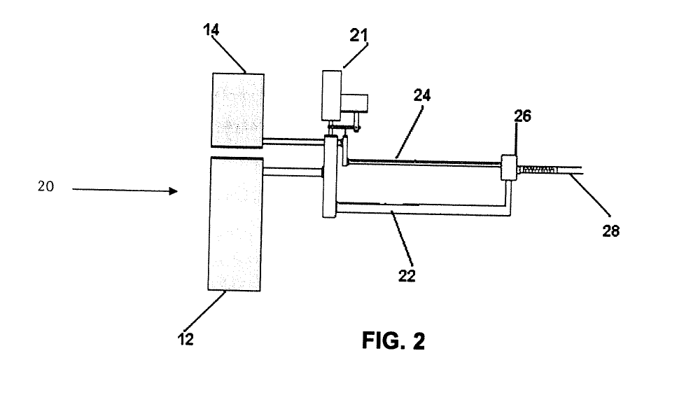

In one embodiment, the coating composition is supplied to the flexible conduit through use of a pumping unit 20 as depicted in FIG. 2. The pumping unit 20 utilizes any motorized dual positive displacement pump 21 known in the industry that is designed to dispense liquid. As illustrated in FIG. 1, the pumping unit 20 comprises a resin line 22 to distribute the coating composition and a catalyst line 24 to distribute the catalyst. A positive displacement pump 21 meters the conveyance of a precise combination of both the coating composition and catalyst from their respective lines 22, 24 through a mixing valve 26 which is connected to the flexible conduit 32. In an alternative embodiment, the pumping unit 20 may be omitted and the coating composition may be supplied to the flexible conduit 32 through any means known in the art, such as, for example, by storing the coating composition in a reservoir and using gravity to supply the composition to the flexible conduit.

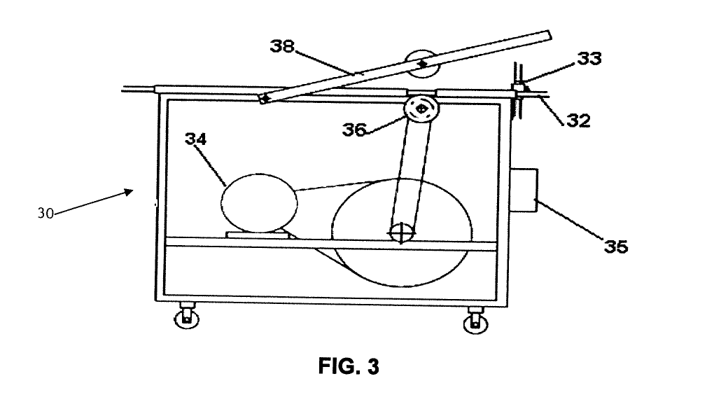

In one embodiment, a pumping unit 20 is attached to an injection unit 30, which is illustrated in FIGS. 3-5. The injection unit 30 generally comprises the flexible conduit 32, which is placed in fluidic communication with the reservoir containing the coating composition, or optionally, the pumping unit 20. If the flexible conduit 32 is placed in fluidic communication with the pumping unit, the flexible conduit 32 is preferably attached to a mixing valve 26 which connects the injection unit 30 in fluidic communication with the pumping unit 20. Arranged within the injection unit 30 is a means for retracting the flexible conduit 32 from the pipe. In one embodiment, the means for retracting the flexible conduit 32 from a pipe is a power unit 34, such as a DC motor, that controls the flexible conduit 32 via a gear mechanism, which may comprise a drive roller 36 and a pinch roller 38. It should be noted that any other type of power unit such as an electric motor, a solar motor, manual motor, fuel motor, hydraulic motor or the like may be used within the injection unit 30, or alternatively, a power unit may be omitted entirely and manual retraction may used. As illustrated in FIGS. 3-5, the flexible conduit 32, which comprises two openings on either end and a channel through which liquids may flow, is threaded through the injection unit 30 and is inserted into one end of a pipe to be coated 37. The pipe to be coated is loaded horizontally onto an assembly 40 configured to axially rotate the pipe, described in detail below. The flexible conduit 32 is retracted from a pipe is at a precise speed through the use of a drive roller 36 and a pinch roller 38 connected to the means for retracting the flexible conduit 32. When the means for retracting the flexible conduit 32 is powered or otherwise engaged, the drive roller 36 engages to move or withdraw the flexible conduit 32 backwards out of the pipe. In conjunction with the engagement of the drive roller 36, the pinch roller 38 is engaged to apply a set pressure onto the retracting flexible conduit 32 thus further controlling the speed at which the flexible conduit 32 is withdrawn from the pipe. The means for retracting the flexible conduit 32 is controlled electrically via a motor speed controller 35 that is easily accessible by an operator. The flexible conduit 32 may further comprise a flow valve 33, which enables beads of the resin coating to be deposited through the flexible conduit 32 onto the interior surface of the pipe in a stream or line. In certain embodiments, the injection unit 30 may only comprise the flexible conduit 32.

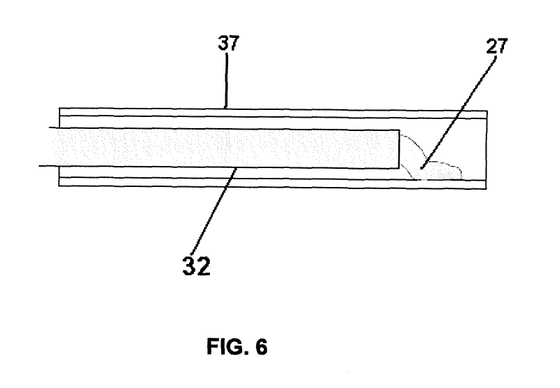

FIG. 6 shows a cross-section of a pipe 37 as the flexible conduit 32 deposits the coating composition 27 onto the interior surface of the pipe. Accordingly, the method of depositing the resin coating 27 into the pipe 37 includes inserting the flexible conduit 32 into a pipe 37 that has been placed in a horizontal position and fitted with an end cap (not shown) at one end. Once the flexible conduit 32 is in proper starting position near the capped end of the pipe, the means for retracting the flexible conduit 32 is powered on to engage the drive roller 36 and the pinch roller 38 to withdraw the flexible conduit 32 out of the pipe 37 in the direction from which it entered. The movement of the flexible conduit 32 in a reverse manner through the pipe is performed at a precise speed through the combined operation of the drive roller 36 and pinch roller 38. Simultaneously with the retraction of the flexible conduit 32, the flow valve 33 is opened and the coating composition 27 is metered from the pumping unit 20 through the flexible conduit 32 and a predetermined volume (or beads) of the coating composition are deposited in a stream onto the interior surface of the pipe 37. The retraction or withdrawal of the flexible conduit 32 from the pipe at a controlled and continuous rate of speed combined with the metering a predetermined volume of coating composition 27 through the flexible conduit 32 enables the coating composition to be applied smoothly, uniformly in thickness and possess excellent surface adhesion on the interior surface of the pipe 37. After the flexible conduit 32 has been completely withdrawn from the pipe 37, the remaining open end of the pipe is fitted with an end cap (not shown) and the pipe 37 is ready for rotation on the assembly 40 configured to axially rotate the pipe.

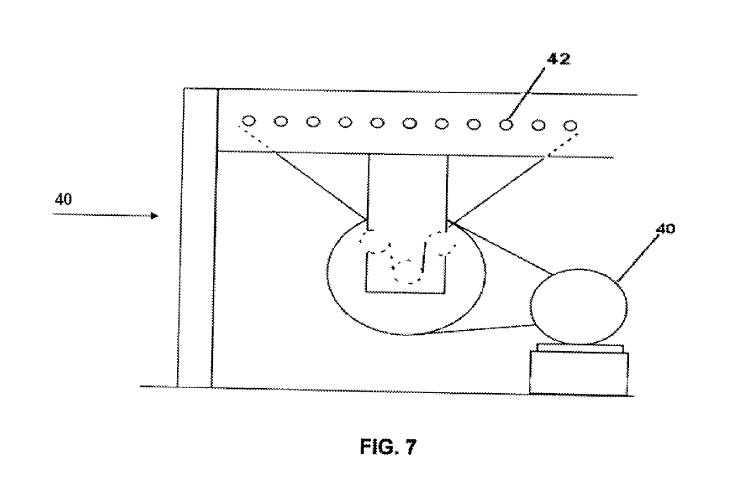

After the pipe has been filled with a precise volume of coating composition from the flexible conduit 32, the pipe is then rotated about its horizontal axis on the assembly 40. The assembly 40 is illustrated in FIGS. 7-11. The assembly 40 is generally comprised of a plurality of openings 42, wherein the openings are configured to hold both ends of a pipe and to further hold a number of pipes arranged horizontally in a parallel manner, a means for rotating a pipe 44, and, optionally, an air clutch 46.

The pipe or pipes to be coated are disposed horizontally across the assembly 40 by inserting each end of the pipe 37 through the openings 42. The assembly 40 can hold any number of pipes to be coated and will be limited only by the amount of space available in a particular facility. In one embodiment, the assembly 40 holds between 1 and 60 pipes. In another embodiment, the assembly 40 holds more than 60 pipes. It is preferred, but not required, that the assembly 40 be divided into sections in order to group a number of pipes together and separate or segregate different groups of pipes for rotation independently from other groups of pipes. The control of individual sections on the assembly 40 is accomplished through use of an air clutch 46 that is attached to the means for rotating a pipe 44. In one embodiment, the means for rotating a pipe 44 comprises a power unit, such as a DC motor, which controls the rotational speed of the pipe via a gear mechanism. It should be noted that any other type of power unit such as an electric motor, a solar motor, fuel motor, manual motor, hydraulic motor or the like may be used within the assembly 40. The air clutch 46 enables one section of pipes to be rotated while other sections are being loaded, coated, or unloaded on the assembly 40.

The rotation of the pipe on the assembly 40 is at a precise rotation speed via the means for rotating a pipe 44 such that centrifugal forces annularly distribute the coating composition inside the pipe 37 thereby forming a smooth and uniform coating on the interior surface of the pipe. The distribution of the coating composition via centrifugal force ensures that no air is trapped in the coating composition and an even distribution of the coating composition throughout the entire interior surface of the pipe is accomplished. The rotation speed of the pipe is of sufficient revolutions per minute (rpm or rpms) and will depend upon the diameter of the pipe to be coated. In one embodiment, the pipe comprises a one inch diameter and the rotation speed on the assembly 40 is between about 800 rpms and about 900 rpms, preferably between about 820 rpms and about 830 rpms. Most preferably, a pipe having a one inch diameter will be rotated at about 825 rpms on the assembly 40.

The pipe is rotated on the assembly 40 at a preset rpm for a specific period of time in order to allow the coating composition to completely and evenly coat the entire interior diameter of the pipe. Preferably, the pipe is rotated on the assembly 40 for between about 30 minutes and about 90 minutes. More preferably, the pipe is rotated on the assembly 40 for between about 40 minutes and about 60 minutes. Most preferably, the pipe is rotated on the assembly 40 for about 45 minutes.

In one embodiment, it is contemplated that the thickness of the coating that is distributed inside a pipe having a one inch diameter in accordance with the system and methods of the present invention can be less than or equal to about one-quarter of an inch. Preferably, the thickness of the coating on the interior diameter of a pipe having a one inch diameter will be between about one-eighth of an inch to about one-quarter of inch, and is preferably about 3/16 of an inch. In an alternative embodiment, the thickness of the coating will be greater than one-quarter of an inch, depending upon the size of the pipe to be coated and the intended use for the pipe.

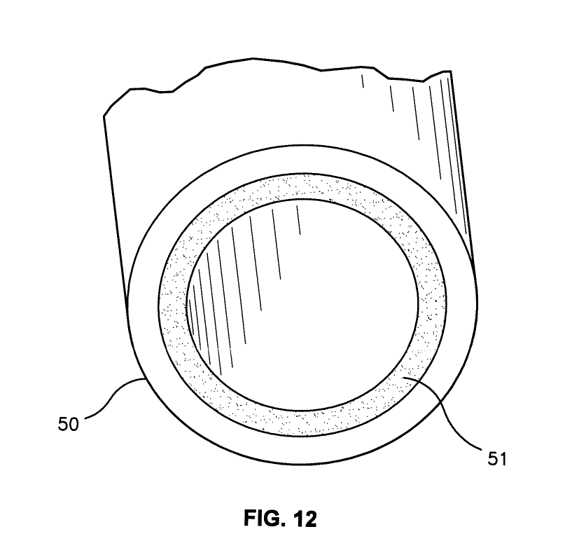

After the pipe has been uniformly coated following the rotation of the pipe on the assembly 40, the pipe is removed from the assembly and the coating composition in the resultant coated pipe 50 is allowed to cure. The coating in the coated pipe 50 may be cured naturally at room temperature with the passage of time or may be force cured by the application of heat to the pipe. FIG. 12 shows the resultant coated pipe 50 made in accordance with the methods and systems of the present invention. As illustrated in FIG. 12, the resultant coated pipe 50 possesses a seamless coating 51 having a uniform or consistent thickness about the interior diameter of the pipe such that the coating does not vary in thickness at any point on the inside surface of the pipe. Uniform coating thicknesses in the range of less than or equal to about one-quarter of an inch about the interior diameter are preferred. However, one of skill in the art will appreciate that the thickness of the uniform coating 51 may be greater than one-quarter of an inch and will depend upon the size of the pipe being coated and the particular application requirements for the pipe.

The systems and methods of the present invention are well adapted to be used in the oil and gas pipe industry. A method of using the coated pipe in a pipeline for transporting corrosive petroleum fluids is also disclosed, wherein the coated pipe is made in accordance with the methods and systems of the present invention. The method of using the coated pipe in the transmission of corrosive petroleum fluids generally comprises uniformly coating and curing the interior diameter of a metal pipe with a coating composition, connecting a plurality of uniformly coated metal pipes together to form a pipeline, and transporting corrosive petroleum fluids through the pipeline. Of course, the method and apparatus described herein may be used in nearly all industries involving the transport of liquids through a pipeline.

An important feature of the present invention is the ability to provide precise and metered application of the coating composition to the pipe being coated, as well as rotation of the pipe at a precise rpm appropriate for the particular diameter of the pipe. A user can input a specific motor speed for withdrawal or retraction of the flexible conduit from the pipe, as well as a rotation speed for the assembly configured to axially rotate the pipe, dependent upon a variety of factors, including the interior diameter of the pipe to be coated, the displacement of the pump being used, and the desired thickness of coating inside the pipe. These adjustable settings impact the amount of coating composition to be deposited inside the pipe, which amount directly affects the thickness of the resultant coating inside the pipe. Accordingly, the present invention provides a “user-adjustable” pipe coating system that may be adjusted in the field to a specific application by increasing or decreasing the motor speeds on the injection unit and assembly configured to axially rotate the pipe. These motor speeds may further be adjusted between applications. This feature is important in making an economical commercial system, as it would not be feasible to provide a customized coating device to each user.

The features that may be user-adjusted include:

The motor speed on the injector unit, which impacts the speed of the drive roller and the travel speed of the flexible conduit as it is withdrawn from the pipe. The slower the speed of the motor, the slower the drive roller pulls the flexible conduit from the pipe and the more resin coating is deposited inside the pipe. Typically, motor speed on the injector unit is capable of varying between speeds 0 rpm to approximately 1750 rpm. For a pipe having a length of about 25 feet and an interior diameter of about one inch, it is preferable to adjust the motor speed and drive roller speed such that the flexible conduit is withdrawn from the pipe at a speed of about 1 foot/second (ft/s). One of skill in the art will appreciate that the speed of the drive roller, the motor, and the flexible conduit as it is retracted from the pipe will depend upon a variety of factors, including the size of the roller being used, the size of the pipe, the displacement of the pump, and the desired thickness of the resin coating.

The motor speed on the assembly configured to axially rotate the pipe refers to the rotation speed of the pipe on the assembly. The assembly may be programmed to rotate the pipe at a precise rpm for a specific period of time to uniformly coat the interior surface of the pipe. Typically motor speed on the assembly provides rotation of the pipe between about 820 rpm and about 830 rpm. Preferably, the motor speed on the assembly machine provides rotation of the pipe at about 825 rpm.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

What is claimed is:

1. A method for coating an interior surface of a pipe, the method comprising the steps of:
a. disposing a pipe about a horizontal axis on an assembly configured to axially rotate the pipe;
b. supplying a quantity of a coating composition to a flexible conduit;
c. inserting the flexible conduit into the pipe;
d. depositing the coating composition into the pipe through the flexible conduit; and,
e. rotating the pipe on the assembly at a selected rate of speed to form a uniform coating about the interior surface of the pipe.

2. The method of claim 1, wherein the coating composition comprises a thermosetting synthetic resin, a cross-linking agent, at least one filler for increasing tensile strength, a flex agent for adding flexibility, and a catalyst.

3. The method of claim 2, wherein the thermosetting synthetic resin is selected from the group consisting of polyester resin, polyurethane resin, vinyl ester resin, epoxy resin, nylon resin, and combinations thereof.

4. The method of claim 2, wherein the cross-linking agent is any agent that reacts with the resin to form cross-links.

5. The method of claim 4, wherein the cross-linking agent is styrene.

6. The method of claim 2, wherein the at least one filler is selected from the group consisting of calcium carbonate, fibrous reinforcements, and combinations thereof.

7. The method of claim 2, wherein the flex agent is putty resin.

8. The method of claim 1, wherein the method further comprises withdrawing the flexible conduit from the pipe at a selected rate of speed while depositing the coating composition in a stream of uniform beads inside the pipe.

9. The method of claim 8, wherein a drive mechanism is engaged to withdraw the flexible conduit from the pipe at a selected rate of speed.

10. The method of claim 1, wherein the pipe is rotated on the assembly between approximately 800 rpms and 900 rpms about the horizontal axis of the pipe.

11. The method of claim 1, wherein the pipe is rotated on the assembly between approximately 820 rpms and 830 rpms about the horizontal axis of the pipe.

12. The method of claim 1, wherein the pipe is rotated on the assembly at approximately 825 rpms about the horizontal axis of the pipe.

13. The method of claim 1, wherein rotating the pipe continues for a period of time sufficient to evenly distribute the coating composition about the interior surface of the pipe.

14. The method of claim 13, wherein the period of time is between about 30 minutes and about 90 minutes.

15. The method of claim 13, wherein the period of time is about 45 minutes.

16. The method of claim 1, wherein the method further comprises the step of curing the coating for a period of time sufficient to form a coated pipe.

17. The method of claim 16, wherein curing the coating composition comprises allowing the composition to sit for a period of time at room temperature.

18. The method of claim 1, wherein the coating formed on the pipe has a thickness of less than about one-quarter of an inch.

19. The method of claim 1, wherein the coating formed on the pipe has a thickness of between about one-eighth of an inch to about one-quarter of an inch.

20. The method of claim 1, wherein the coating formed on the pipe has a thickness of about 3/16 of an inch.

21. The method of claim 1, wherein the method further comprises affixing end caps on the pipe.

22. A method of coating an interior surface of a pipe, the method comprising the steps of:
a. disposing a pipe about a horizontal axis on an assembly configured to axially rotate the pipe;
b. supplying a quantity of a coating composition to a flexible conduit;
c. inserting the flexible conduit into the pipe;
d. withdrawing the flexible conduit from the pipe at a selected rate of speed while depositing the coating composition in a stream of uniform beads inside the pipe;
e. rotating the pipe on the assembly at a selected rate of speed to form a uniform coating about the interior surface of the pipe; and,
f. curing the coating for a period of time sufficient to form a coated pipe.

23. A system for coating an interior surface of a pipe, the system comprising:
a. reservoir for receiving a quantity of a coating composition;
b. a flexible conduit in fluidic communication with the reservoir; and,
c. an assembly configured to axially rotate a pipe.

24. The system of claim 23, wherein the system further comprises a means for withdrawing the flexible conduit from the pipe at a selected rate of speed.

25. The system of claim 24, wherein the means for withdrawing the flexible conduit from the pipe comprises a power unit.

26. The system of claim 25 wherein the means for withdrawing the flexible conduit from the pipe further comprises a roller.

27. The system of claim 25, wherein the power unit comprises a motor.

28. A system for coating the interior surface of a pipe, the system comprising:
a. reservoir for receiving a quantity of a coating composition;
b. a flexible conduit in fluidic communication with the reservoir;
c. a means for withdrawing the flexible conduit from the pipe at a selected rate of speed; and,
d. an assembly configured to axially rotate a pipe.

29. A coated pipe for use in the transmission of corrosive petroleum fluids, the pipe comprising:
a. an interior surface comprising a diameter of at least about one inch; and
b. a coating affixed to the interior surface of the pipe, wherein the coating is integral to the interior diameter and is uniform in thickness about the interior diameter.

30. The coated pipe of claim 29, wherein the pipe is a metal pipe.

31. The coated pipe of claim 30, wherein the metal is steel.

32. The coated pipe of claim 29, wherein the pipe has a length of between about 10 feet and about 50 feet.

33. The coated pipe of claim 29, wherein the pipe has a length of between about 20 feet and about 40 feet.

34. The coated pipe of claim 29, wherein the pipe has a length of between about 25 feet and about 30 feet.

35. The coated pipe of claim 29, wherein the coated pipe has a tensile strength of less than or equal to 85,000 psi.

36. The coated pipe of claim 29, wherein the coated pipe has a tensile strength of less than or equal to 50,000 psi.

37. The coated pipe of claim 29, wherein the coated pipe has a bending radius of less than or equal to 4 feet.

38. The coated pipe of claim 37, wherein the bending radius is between about ⅛ of an inch to about 4 feet.

39. The coated pipe of claim 29, wherein the coating has a uniform thickness of less than or equal to ¼ of an inch.

40. The coated pipe of claim 29, wherein the coating has a uniform thickness of between about one-eighth of an inch and about one-quarter of an inch.

41. The coated pipe of claim 29, wherein the coating has a uniform thickness of about 3/16 of an inch.

42. The coated pipe of claim 29, wherein the coated pipe is impervious to corrosive petroleum fluids.

43. A coated metal pipe for use in the transmission of corrosive petroleum fluids, the coated pipe comprising:
a. an interior surface comprising a diameter of at least about one inch and a length of between about 10 feet and about 50 feet; and, b. a coating affixed to the interior surface of the pipe, wherein the coating is integral to the interior diameter and comprises a uniform thickness of between about ⅛ of an inch and about ¼ of an inch;
wherein the coating provides the coated pipe with a tensile strength of less than or equal to 85,000 psi, a bending radius of less than or equal to 4 feet, and allows for the transmission of corrosive fluids through the pipe without corroding the interior of the pipe.

44. A method of using a coated pipe in a pipeline for the transmission of corrosive petroleum fluids, the method comprising:
a. providing a coated pipe, wherein the coated pipe comprises an interior surface having a diameter of at least about one inch and a coating affixed to the interior surface of the pipe, wherein the coating is integral to the interior diameter and is uniform in thickness about the interior diameter of the pipe;
b. connecting a plurality of coated pipes together to form a pipeline; and,
c. transporting corrosive petroleum fluids through the pipeline.

45. The method of claim 44, wherein the pipe has a length of between about 10 feet and about 50 feet.

46. The method of claim 44, the method further comprising attaching the pipeline to a location in which corrosive fluids are to be withdrawn.

47. A method of using a coated pipe in a pipeline for the transmission of corrosive petroleum fluids, the method comprising:
a. providing a coated pipe, wherein the coated pipe comprises an interior surface having a diameter of at least about one inch and a coating affixed to the interior surface of the pipe, wherein the coating is integral to the interior diameter and is uniform in thickness about the interior diameter of the pipe;
b. connecting a plurality of uniformly coated together to form a pipeline;
c. attaching the pipeline to a location in which corrosive petroleum fluids are to be withdrawn; and
d. transporting the corrosive petroleum fluids through the pipeline.
